(19) United States
(12) Patent Application Publication
(10) Pub. No.: US 2016/0110372 A1
(43) Pub. Date: Apr. 21, 2016

(54) METHOD AND APPARATUS FOR PROVIDING LOCATION-BASED SOCIAL SEARCH SERVICE

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Ho-Sik CHO, Suwon-si (KR); Jae-Gil LEE, Daejeon (KR); Min-Soo CHOY, Seoul (KR); Cheol-Ju HWANG, Yongin-si (KR)

(73) Assignees: KOREA ADVANCED INSTITUTE OF SCIENCE AND TECHNOLOGY, Daejeon (KR); SAMSUNG ELECTRONICS CO., LTD., Suwon-si (KR)

(21) Appl. No.: 14/635,647

(22) Filed: Mar. 2, 2015

(30) Foreign Application Priority Data
Oct. 17, 2014 (KR) 10-2014-0141024

(51) Int. Cl. G06F 17/30

(52) U.S. Cl. CPC G06F 17/3087; G06F 17/30554

(57) ABSTRACT

Provided is a method of providing a location-based social search service. The method includes collecting, from a social network system, one or more pieces of visit history information including at least one of visit information of social search service users in association with at least a place and review data associated with the place, and storing the collected information; selecting a topic for each topic category from the visit history information; when a location-based query is received from at least one of the users, extracting a topic for each topic category from the location-based query; analyzing, for each topic category, a relationship between the topic extracted from the location-based query and the topic selected from the visit history information, and selecting at least one of the users as an expert.

### CROSS-REFERENCE TO RELATED APPLICATION

This application claims priority from Korean Application Serial No. 10-2014-0141024, which was filed in the Korean Intellectual Property Office on Oct. 17, 2014, the entire content of which is hereby incorporated by reference.

### TECHNICAL FIELD

The exemplary embodiments of this application relate to a method and apparatus for providing a location-based social search service.

### BACKGROUND

As the dissemination of electronic devices, such as, smart phones, tablet Personal Computers (PCs), or the like, has broadened, people are able to search for and obtain desired information through electronic devices, irrespective of time and place. In addition, the ratio of searches executed by mobile devices occupies 10 to 30% of all searches executed through desktop computers and mobile devices, and the ratio of searches using mobile devices has been gradually increasing.

Additionally, recently, due to the popularity of social network services, for example, Facebook, Twitter, or the like, the development of social search technology using social network systems has been actively conducted. Social search technology is a new search paradigm that retrieves a user who is an expert with regards to a particular query.

### SUMMARY

A related art search technology provided from web sites such as Google or the like has provided satisfactory search results for objective and factual queries, but has failed to provide an acceptable result for queries such as location-based questions that require recommendations or subjective opinions.

In addition, Aardvark, which is a social search system which uses the related art social search technology, searches for users who can provide the best answer to a particular query based on location information included in social network profiles of the users when a location-based question is provided. However, the location information is broad, for example, “Seoul” and thus, it is difficult to evaluate, based on the location information, the expertise of a user for a detailed location. In other words, it is difficult to say that a resident of “Seoul” is an expert for all of the areas of Seoul (for example, Apgujeong-dong).

In addition, simple string matches between a query and a keyword of a user have been used in the related art to calculate the degree of expertise of a user for location-based queries. The related art scheme may conclude that a user who does not have a keyword that matches the query fails to have expertise. For example, when a keyword “Apgujeong-dong” is provided, the related art scheme may output a result indicating that a corresponding user does not exist when a user that matches Apgujeong-dong does not exist. However, it may be useful to recommend a user who matches “Sinsa-dong” which is an area nearby to Apgujeong-dong. Accordingly, there is a need for the development of a technology that searches for and recommends similar users as the second best user, which is an advanced technology from the simple string match technology.

Therefore, various exemplary embodiments provide a method and apparatus for providing a location-based social search service that provides a best answer to a user (questioner) when the user asks a question that requires a recommendation or a subjective opinion.

Various exemplary embodiments provide a method and apparatus for providing a location-based social search service that evaluates the expertise of other users of a social search service to determine whether the other users would be able to correctly answer a question when a questioner asks a question in the social search service, and selects a user with the highest level of expertise to answer the question so as to select as an expert who can give the best answer to the question.

In addition, various exemplary embodiments provide a method and apparatus for providing a location-based social search service that selects a user who can provide the second best answer, when a questioner asks a question in a social search service and a user who best matches the question is not retrieved.

In addition, various exemplary embodiments provide a method and apparatus for providing a location-based social search service that may consider a significantly small area such as a predetermined “store”, in addition to a broad area such as a “neighborhood”.

According to an aspect of the exemplary embodiments, there is provided a method of providing a location-based social search service, the method including: collecting, from a social network system, one or more pieces of visit history information including at least one of visit information of social search service users in association with at least a location, and review data associated with the location, and storing the collected information; selecting a topic for each topic category from the visit history information; extracting a topic for each topic category from the location-based query when a location-based query is received from at least one of the users; and analyzing, for each topic category, a relationship between the topic extracted from the location-based query and the topic selected from the visit history information and selecting at least one of the users as an expert.

According to another aspect of the exemplary embodiments, there is provided an apparatus which provides a location-based social search service, the apparatus including: a communication unit; and a controller configured to execute a control operation to collect, from a social network system, one or more pieces of visit history information including at least one of visit information of social search service users associated with at least a location, and review data associated with the location and to store the collected information; to select a topic for each topic category from the visit history information; to extract a topic for each topic category from a location-based query when the location-based query is received from at least one of the users; to analyze, for each topic category, a relationship between the topic extracted from the location-based query and the topic selected from the visit history information, and to select at least one of the users as an expert.

A method for providing a location-based social search service according to various exemplary embodiments may provide a best answer to a predetermined user (questioner) when the user asks a question that requires a recommendation or a subjective opinion through a social search service.

An apparatus for providing a location-based social search service according to various exemplary embodiments may provide a best answer to a predetermined user (questioner) when the user asks a question that requires a recommendation or a subjective opinion through a social search service.

Additionally, a method for providing a location-based search service according to various exemplary embodiments may evaluate the expertise of other users who use a social search service to answer a question when a questioner asks the question in a social search service, and may select a user who matches the question as an expert who can provide the best answer to the question. In addition, when selection of a user who matches the question is impossible, a user who is qualified to give the second best answer may be selected.

Additionally, an apparatus for providing a location-based search service according to various exemplary embodiments may evaluate the expertise of other users who use a social search service to answer a question when a questioner asks the question in a social search service, and may select a user who matches the question as an expert who can provide the best answer to the question. In addition, when selection of a user who matches the question is impossible, a user who is qualified to give the second best answer may be selected.

Additionally, a method for providing a location-based social search service according to various exemplary embodiments may provide a location-based social search service that may consider a small area or location such as a predetermined “store” in addition to a large area or location such as “neighborhood”.

Additionally, an apparatus for providing a location-based social search service according to various exemplary embodiments may provide a location-based social search service that may consider a small area or location such as a predetermined “store” in addition to a large area or location such as “neighborhood”.

### BRIEF DESCRIPTION OF THE DRAWINGS

The above and other aspects and features will be more apparent from the following detailed description taken in conjunction with the accompanying drawings, in which:

FIG. 1 is a diagram illustrating a location-based social search service according to an exemplary embodiment;

FIG. 2 is a diagram illustrating a system that provides a location-based social search service according to an exemplary embodiment;

FIG. 3 is a diagram illustrating a location-based social search service operation according to an exemplary embodiment;

FIG. 4 is a flowchart illustrating a location-based social search service operation according to an exemplary embodiment;

FIG. 5 and FIGS. 6A through 6E are diagrams illustrating an operation of selecting an expert in a location-based social search service operation according to an exemplary embodiment;

FIG. 7 is a flowchart illustrating an operation of selecting an expert in a location-based social search service operation according to an exemplary embodiment;

FIGS. 8A and 8B are flowcharts illustrating a location-based social search operation of an electronic device that uses a location-based social search service according to an exemplary embodiment;

FIGS. 9A through 9E are diagrams illustrating a screen for displaying of a location-based social search operation of an electronic device that uses a location-based social search service according to an exemplary embodiment;

FIGS. 10A and 10B are diagrams illustrating screens for displaying a result of a location-based social search operation of an electronic device that uses a location-based social search service according to an exemplary embodiment;

FIG. 11 is a block diagram of a network environment including an electronic device according to various exemplary embodiments; and

FIG. 12 is a block diagram of an electronic device according to various exemplary embodiments.

### DETAILED DESCRIPTION OF EXEMPLARY EMBODIMENTS

Hereinafter, various exemplary embodiments will be described with reference to enclosed drawings. The present disclosure may be modified in various forms and include various exemplary embodiments, but specific examples are illustrated in the drawings and described in the description. However, the description is not intended to limit the present disclosure to the specific exemplary embodiments, and it shall be appreciated that all the changes, equivalents and substitutions belonging to the idea and technical scope of the present disclosure are included in the present disclosure. In the description of the drawings, identical or similar reference numerals are used to designate identical or similar elements.

The term “include” or “may include” refers to the existence of a corresponding disclosed function, operation or component which can be used in various exemplary embodiments of the present disclosure and does not limit one or more additional functions, operations, or components. Further, as used in exemplary embodiment of the present disclosure, the terms “include”, “have” and their conjugates may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various exemplary embodiments, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various exemplary embodiments of the present disclosure may modify various components of various exemplary embodiments but does not limit the corresponding components. For example, the above expressions do not limit the sequence and/or importance of the corresponding elements. The expressions may be used to distinguish a component element from another component element. For example, a first user device and a second user device indicate different user devices although both of them are user devices. For example, without departing from the scope of the present disclosure, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

In the present disclosure, the terms are used to describe a specific exemplary embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Electronic devices according to various exemplary embodiments may be devices adopting a communication function. For example, the electronic devices may include at least one of smart phones, tablet personal computers (PCs), mobile phones, video phones, e-book readers, desktop PCs, laptop PCs, netbook computers, personal digital assistants (PDAs), portable multimedia players (PMPs), MP3 players, mobile medical devices, cameras, wearable devices {e.g., head-mounted-devices (HMDs) such as electronic glasses}, electronic clothes, electronic bracelets, electronic necklaces, electronic appcessories, electronic tattoos, or smart watches.

According to an exemplary embodiment, an electronic device may be a smart home appliance with a communication function. The smart home appliance as an example of the electronic device may include at least one of, for example, a television, a Digital Video Disk (DVD) player, an audio system, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to an exemplary embodiment, an electronic device may include at least one of various medical devices such as a magnetic resonance angiography (MRA) scanner, a magnetic resonance imaging (MRI) scanner, a computed tomography (CT) scanner, a scanner, an ultrasonograph, or the like, a navigation device, a Global Positioning System (GPS) receiver, an Event Data Recoder (EDR), a Flight Data Recoder (FDR), a vehicle infotainment device, an electronic equipment for ships (for example a ship navigation device and gyro-compass and the like, avionics, a security device, a head unit for vehicle, an industrial or household robot, ATM (automatic teller machine) in banking facilities or POS (point of sales) in stores.

According to another exemplary embodiment, the electronic devices may include at least one of furniture or a part of a building/structure having a communication function, electronic boards, electronic signature receiving devices, projectors, or various measuring equipment (e.g., equipment for a water supply, an electricity, gases or radio waves). An electronic device according to various exemplary embodiments may be a combination of one or more of the above described various devices. Also, an electronic device according to various exemplary embodiments may be a flexible device. Also, an electronic device according to various exemplary embodiments is not limited to the above described devices.

The term “user” as applied in the various exemplary embodiments may refer to a person who uses an electronic device or a device (for example, an artificial intelligence electronic device) that uses an electronic device.

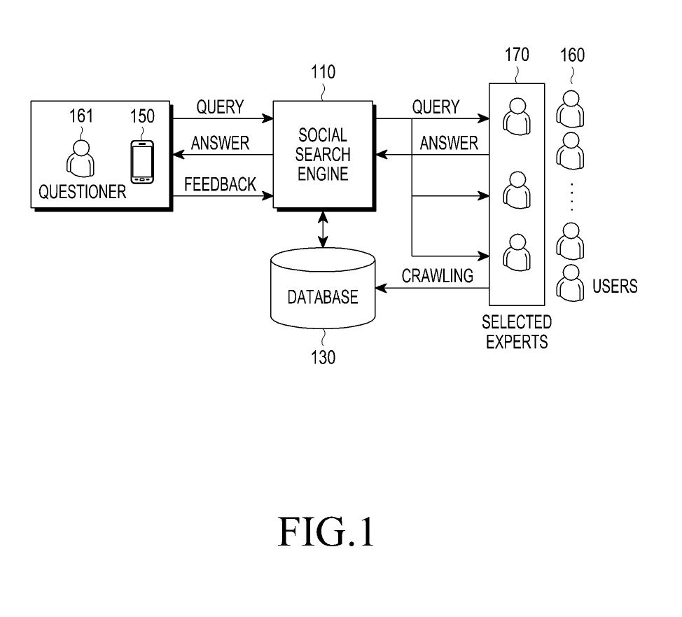

FIG. 1 is a diagram illustrating a location-based social search service according to an exemplary embodiment. Referring to FIG. 1, in a location-based social search service, an apparatus (hereinafter, referred to as a social search engine) that provides a location-based social search service 110 collects, from a social network system, information associated with users 160 who use the location-based social search service, and stores (crawls) the same in a database 130. The information associated with the users 160 may be visit history information including at least one of visit information of the users 160 associated with at least one place or location (for example, check-in data indicating time of visit to the location and a visited store), and review data associated with the place or location (for example, tip or review information; for example, review data indicating time of visit to the location, a visited store or similar establishment, and content of the review). In addition, the information associated with the users 160 may be, for example, friendship information of the users (for example, friendship information associated with users who are set to be friends of the users 160 in a predetermined social network service).

In addition, in the location-based social search service of the exemplary embodiment, when a user (also referred to as a questioner) 161 of the location-based social search service executes a location-based social search service and inputs a question through an electronic device 150, the electronic device 150 may transfer a query corresponding to the question to the social search engine 110. The social search engine 110 that is provided with the query may analyze a relationship between the query and the other users who use the social search service, based on a designated condition, and may evaluate the expertise of each user. The social search engine 110 may select, as an expert 170, at least one user from among the users who received a high score with regard to the relationship between the query and the user, based on the evaluation of the expertise. The process of evaluating the expertise of the users, and selecting the expert, executed by the social search engine 110, will be described in detail.

Additionally, in the location-based social search service of the exemplary embodiment, the social search engine 110 may transfer a query to the user (expert) 170 who is selected as an expert. In addition, the social search engine may receive, from the expert 170, an answer corresponding to the query input through the electronic device, and may transfer the received answer to the questioner 161. Additionally, the questioner 161 may input (feed back) a degree of satisfaction with respect to the received answer of the expert 170, through the electronic device 150, and transfer the same to the social search engine 110. An average value of a degree of satisfaction, fed back by users 160, with respect to the corresponding expert 170 may also be transferred to the questioner 161 when the questioner 161 receives information associated with the selected expert 170 or receives an answer of the selected expert 170, so that the questioner 161 may check the reliability of the expert 170.

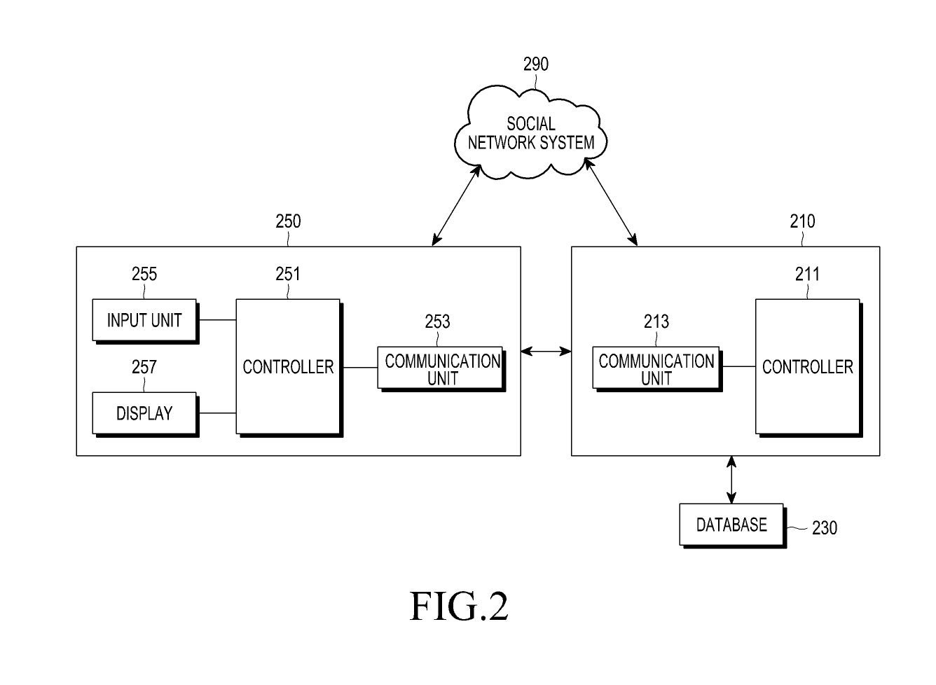

FIG. 2 is a diagram illustrating a system that provides a location-based social search service according to an exemplary embodiment. Referring to FIG. 2, a system that provides a location-based social search service may include a social search engine 210, a database 230, an electronic device 250, and a social network system 290. Additionally, the electronic device 250 may be, for example, a device employed when users of the location-based social search service ask a question using a social search service. Also, the electronic device 250 may be a device employed when the users of the location-based social search service receive a question from a user who uses the social search service, and input an answer to the question.

The social search engine 210 may include a controller 211 and a communication unit 213.

The communication unit 213 may transmit and receive a wireless signal. For example, the communication unit 213 may execute a wireless signal processing operation for wireless communication with an external device, and may be formed to include an antenna, an RF unit, and a MODEM. The RF unit may include an RF transmitter configured to up-convert the frequency of a transmitted signal and amplify the transmitted signal, and an RF receiver configured to low-noise amplify a received signal and down-convert the frequency of the received signal. The MODEM may include, for example, a transmitter configured to encode and modulate a signal to be transmitted, and a receiver configured to decode and demodulate a signal received from the RF unit.

Additionally, the communication unit 213 may include a short-range communication module (not illustrated) such as a wireless LAN module, a Wi-Fi module, a Near Field Communication (NFC) module, a Bluetooth module, a Zigbee communication module, and the like, so that the communication unit 213 may connect to wireless Internet or the like in a place where a radio Access Point (AP) is installed, or may execute a short-range communication operation wirelessly with neighboring devices.

The controller 211 may execute a control operation so as to receive one or more pieces of visit history information including at least one of visit information of social search service users associated with at least one place or location, and review data associated with the place or location, from a social network system 270 that provides a social network service, and to store the received information in the database 230. Additionally, the controller 211 may execute a control operation to select a topic for each topic category from the visit history information, to extract a topic for each topic category from a corresponding location-based query when a location-based query is received from at least one user from among the users of the social search service, to analyze a relationship between the topic extracted from the location-based query and the topic selected from the visit history information, for each topic category, and to select at least one of the users as an expert. Additionally, the controller 211 may execute a control operation to collect friendship information of the social search service users from the social network system through the communication unit 213, and to store the information in the database 230. Additionally, the controller 211 may execute a control operation to take into consideration the friendship information of the service users, for example, to add extra scores to users who are friends with at least one user, when the controller 211 executes a control operation to select at least one of the users as an expert.

The database 230 may store one or more pieces of visit history information including at least one of visit information of social search service users associated with at least one place or location and review data associated with the place or location, based on an operation of the search engine 210. In addition, the database 230 may store friendship information of social search service users, based on an operation of the search engine 210.

The electronic device 250 may include a controller 251, a communication unit 253, an input unit 255, and a display 251.

The communication unit 253 may transmit and receive a wireless or wired signal. For example, the communication unit 253 may execute a wireless signal processing operation for wireless communication with an external device, and may be formed to include an antenna, an RF unit, and a MODEM. The RF unit may include an RF transmitter configured to up-convert the frequency of a transmitted signal and amplify the transmitted signal, and an RF receiver configured to low-noise amplify a received signal and down-convert the frequency of the received signal. The MODEM may include, for example, a transmitter configured to encode and modulate a signal to be transmitted, and a receiver configured to decode and demodulate a signal received from the RF unit.

Additionally, the communication unit 253 may include a short-range communication module (not illustrated) such as a wireless LAN module, a Wi-Fi module, an NFC module, a Bluetooth module, a Zigbee communication module, and the like, so that the communication unit 213 may be connected to wireless Internet or the like in a place where a radio AP is installed, or may execute a short-range communication operation wirelessly with neighboring devices.

The input unit 255 may receive an input of a user, and may be formed of, but not limited to, a touch screen (not illustrated) which will be described below. In addition, the input unit 255 may include at least one button (not illustrated) from among a power/lock button that may be formed on the front side, lateral sides, or the back side of the housing of the electronic device 250, and may also include a microphone (not illustrated).

The display 251 may display execution images of various application programs, an operation state, a menu state, and the like, and may be implemented as a touch screen and a touch screen controller (not illustrated).

The touch screen may receive an input from a user, and may display an execution image of an applicant program, an operation state, and a menu state. That is, the touch screen provides a user with a User Interface (UI) corresponding to various services, for example, a voice call, a data transmission, broadcasting, and photographing. The touch screen may transmit an analog signal corresponding to at least one touch input to a user interface, to the touch screen controller. The touch screen may receive at least one touch through a body part of a user (for example, a finger including a thumb) or a touchable input device (for example, a stylus pen). Additionally, the touch screen may receive a continuous motion of at least one touch, from among at least one touch. The touch screen may transmit an analog signal corresponding to a continuous motion of an input touch, to the touch screen controller.

Additionally, the touch may not be limited to direct contact with a body part of a user or a touchable input device, and may include a contactless touch. The distance which may be detected by the touch screen may change according to the capability or structure of the electronic device 250, and the touch screen is especially configured to distinctively output a value detected through a touch event and a value detected through a hovering event (for example, a current value, or the like), in order to distinguish a touch event by contact with a body part of the user or a touchable input device, and a contactless input event, for example, a hovering event. Further, the touch screen outputs different detected values, for example, a current value or the like, based on a distance between the touch screen and a space where the hovering event is generated.

The touch screen may be implemented, for example, as a resistive type, a capacitive type, an infrared type, or an acoustic wave type.

The touch screen controller may convert an analog signal received from the touch screen into a digital signal (for example, X and Y coordinates), and may transmit the same to the controller 251. The controller 251 may control the touch screen by using the digital signal received from the touch screen controller. For example, the controller 251 enables a shortcut icon (not illustrated) displayed on the touch screen to be selected or executed in response to a touch event or a hovering event. Further, the touch screen controller may be included in the controller 251.

The touch screen controller detects a value, for example, a current value and the like, output through the touch screen and identifies a distance between the touch screen and the space in which the hovering event is generated. Then, the touch screen controller converts the identified distance value into a digital signal, for example, a Z coordinate, and provides the controller 251 with the digital signal.

The touch screen may include at least two touch screen panels which detect a touch or proximity of a user's body part or a touchable input device in order to simultaneously receive inputs of the user's body part and the touchable input device. The at least two touch screen panels provide different output values to the touch screen controller, and the touch screen controller may recognize the values input into the at least two touch screen panels to be different values so as to distinguish whether the input from the screen is input by a body part of the user or input by the touchable input means.

The controller 251 may include a CPU (not illustrated), a ROM (not illustrated) storing a control program for controlling an electronic device, and a RAM (not illustrated) used for storing a signal or data input from an external source or used as a memory area for a task executed in the electronic device. The CPU (not illustrated) may include a single core CPU and a multiple core CPU such as a dual core CPU, a triple core CPU and a quad core CPU. The CPU (not illustrated), the ROM (not illustrated) and the RAM (not illustrated) are connected to one another through an internal bus.

The controller 251 may control the communication unit 253, the input unit 255, and the display 257.

The controller 251 may control a location-based social search operation of an electronic device according to an exemplary embodiment o. For example, when the location-based social search service is executed and a question is input based on an input of the user provided through the input unit 255, the controller 251 transfers a query corresponding to the question to the social search engine 210, and may receive expert information from the social search engine 210 through the communication unit 253 so as to display the same in the display 257. The controller 251 may receive an answer to the question from the expert and may display the same in the display unit 257.

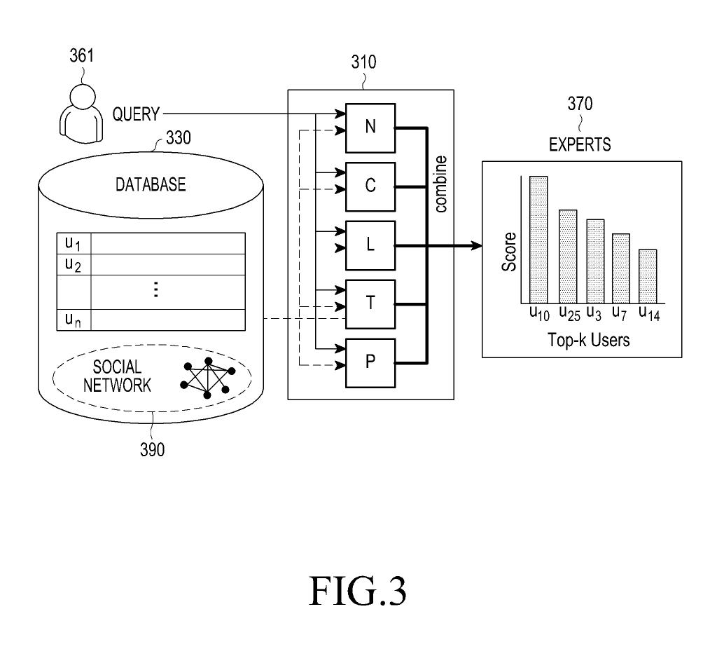

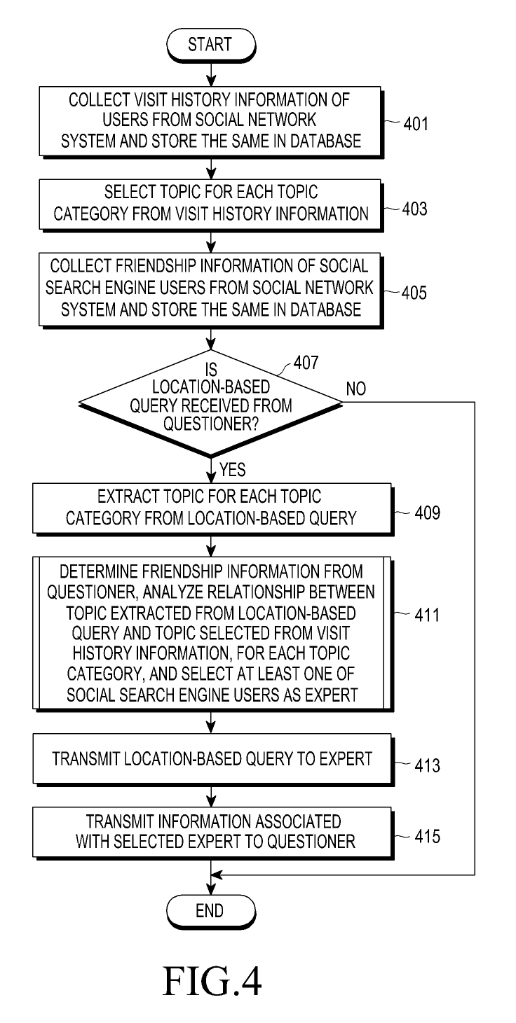

FIG. 3 is a diagram illustrating a location-based social search service operation according to an exemplary embodiment, and FIG. 4 is a flowchart illustrating a location-based social search service operation according to an exemplary embodiment.

Referring to FIGS. 3 and 4, a social search engine 310 that provides a location-based social search service may collect, from a social network system 390, one or more pieces of visit history information including at least one of visit information of social search service users u₁, u₂, . . . , and uₙ in association with at least one place or location and review data associated with the place or location. Additionally, the social search engine 310 may select a topic from the visit history information for each topic category, for example, a topic corresponding to a location (L), a type of business (C), a time (T), a store name (N), or other detailed information (P), and store the same in a database 330. When the social search engine 310 receives a location-based query from at least one user (questioner) 361 from among the users, the social search engine 310 may extract a topic from the location-based query for each topic category, for example, a topic corresponding to, for example, a location, a type of business, a time, a store name, or other detailed information. The social search engine 310 may analyze a relationship between the topic extracted from the location-based query and the topic selected from the visit history information, for each topic category, may calculate scores of each user through evaluation of their level of expertise, and may select at least one of the users as an expert 370.

Referring to FIG. 4, in operation 401, a social search engine may collect visit history information of users from a social network system and may store the same in a database, so that the social search engine may be aware of matters of interest of users who use the location-based social search service in association with a detailed place. The visit history information of the users may be listed for each user and may be stored in the database. Additionally, the visit history information may include significantly detailed information associated with a place visited by each user such as ‘store’ unit.

In operation 403, the social search engine may select a topic for each topic category of the visit history information. The topic may be information that is the smallest unit forming the visit history information, and the topic category may be a group of topics, grouped based on the content of the information. The topic category according to an exemplary embodiment may include a location (L), a type of business (C), a time (T), a store name (N), and other detailed information (P). For example, when visit history information of a predetermined user (for example, check-in data) corresponds to “visited MEALTOP at 11 AM”, “11 AM” and “MEALTOP” may be extracted as topics and may be respectively classified as a time topic category and a store name category.

In operation 405, the social search engine may collect, from the social network system, friendship information of users of the social search engine, and may store the same in the database. For example, the social search engine collects the friendship information of the users from the social network system, recognizes the friendship information of the users over a social network system service, and stores the same in the database.

In operation 407, the social search engine may determine whether a location-based query is received from a questioner. When it is determined that the social search engine receives the location-based query from the questioner in operation 407, the social search engine may execute operation 409. When it is determined that the social search engine fails to receive the location-based query from the questioner in operation 407, the social search engine may terminate an operation of the exemplary embodiments.

In operation 409, the social search engine may extract a topic from the location-based query for each topic category. For example, the location-based query may correspond to “which Italian restaurant in Sinsa dong serves the best Carbonara?”, the social search engine extracts “Sinsa dong”, “the best Carbonara”, and “Italian restaurant” as topics and classifies them as a location topic category, a detailed information topic category, and a business type category, respectively.

In operation 411, the social search engine determines friendship information of the questioner, analyzes a relationship between the topic extracted from the location-based query and the topic selected from the visit history information for each category, and may select at least one of the users of the social search engine as an expert. According to the paradigm of the social search “an answer of a friend is more reliable than that of a stranger”, when at least one of the users is selected as an expert, extra scores may be added to users who have a friendship relationship with at least one user.

In operation 413, the social search engine may transmit the location-based query to the selected expert.

In operation 415, the social search engine may transmit information associated with the selected expert to the questioner.

FIG. 5 is a diagram illustrating an operation of selecting an expert in a location-based social search service operation according to an exemplary embodiment. Referring to FIG. 5, as a question (location-based query) 501 of a questioner is received, a social search engine may analyze elements of the question in operation 503, and may extract, from the question, a topic of a topic category corresponding to location information 5031, business type information 5033, time information 5035, store name information 5037, and detailed information 5039. Subsequently, the social search engine may evaluate the level of expertise of users with respect to the question in operation 505, using the extracted topic and visit history information of the users (answerers) stored in the database 503. The social search engine may select a highly ranked expert 570 based on scores (expertise score) obtained through evaluation of expertise in operation 507.

An operation of selecting an expert through the evaluation of expertise may determine, for example, at least one result from among a result of a conformity ratio of each user with a topic extracted from the location-based query for each topic category, a result of similarity between a topic selected from the visit history information and a topic extracted from the location-based query based on a relationship of inclusion between the topic extracted from the location-based query and the topic selected from the visit history information, and a result of determining a coidentity between a topic selected from the visit history information and a topic extracted from the location-based query, with respect to at least one topic category. In addition, based on the determined result, scores for each user may be calculated, and the expert may be selected based on the calculated scores.

By using the following Equation 1, the expertise evaluation operation will be described in detail.

score(uᵢ,uⱼ,q)=p(uⱼ|uᵢ)·f(p(uⱼ|q),boost_factor(uⱼ,q)) [Equation 1]

(score(uᵢ,uⱼ,q): expertise scores, p(uⱼ|uᵢ): relationship between a questioner and an answerer, p(uⱼ|q): expertise of the answerer with respect to basic question information (location information (5031), business type information (5033), time information (5035), store name information (5037)), boost_factor(uⱼ,q): expertise of the answerer with respect to detailed question information (detailed information (5039)), f(p(uⱼ|q),boost_factor(uⱼ,q)): a process of adding the expertise of the answerer with respect to the basic question information and the expertise of the answerer with respect to the detailed question information, uᵢ: questioner, uⱼ: potential answerer, q: question).

The relationship between the questioner and the answerer of Equation 1 is perceived from the tendency for the questioner to place more trust in answers from friends. When the questioner and the answerer are friends in the social network system service, it may be determined that intimacy exists. For an answerer who is close, extra scores may be added.

In addition, the expertise of the answerer with respect to the basic question information of Equation 1 may be evaluated by applying Equation 2.

p(uⱼ|q)=Σ_{tεT}wₜp(uⱼ|t)p(t|q) [Equation 2]

(p(uⱼ|t): expertise of a user for a topic, p(t|q): correlation between a question and a topic)

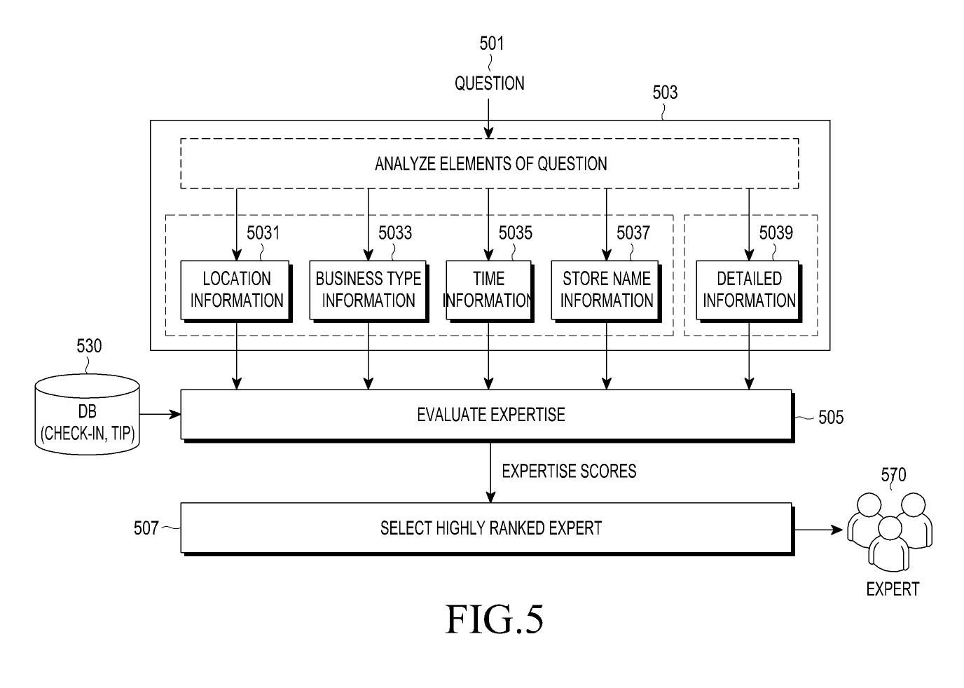

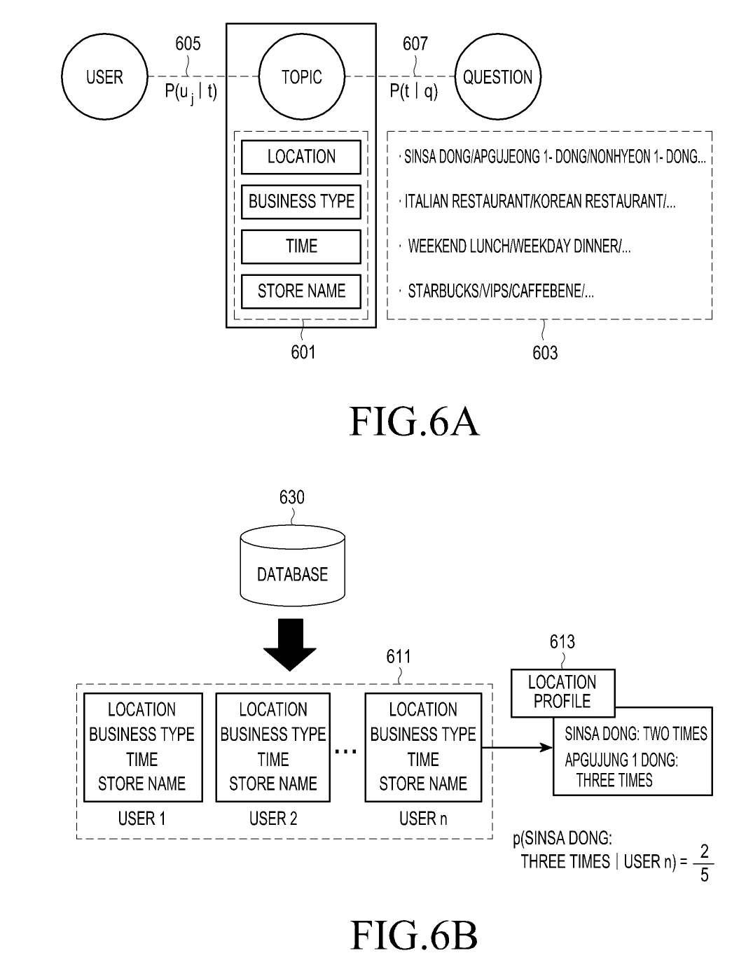

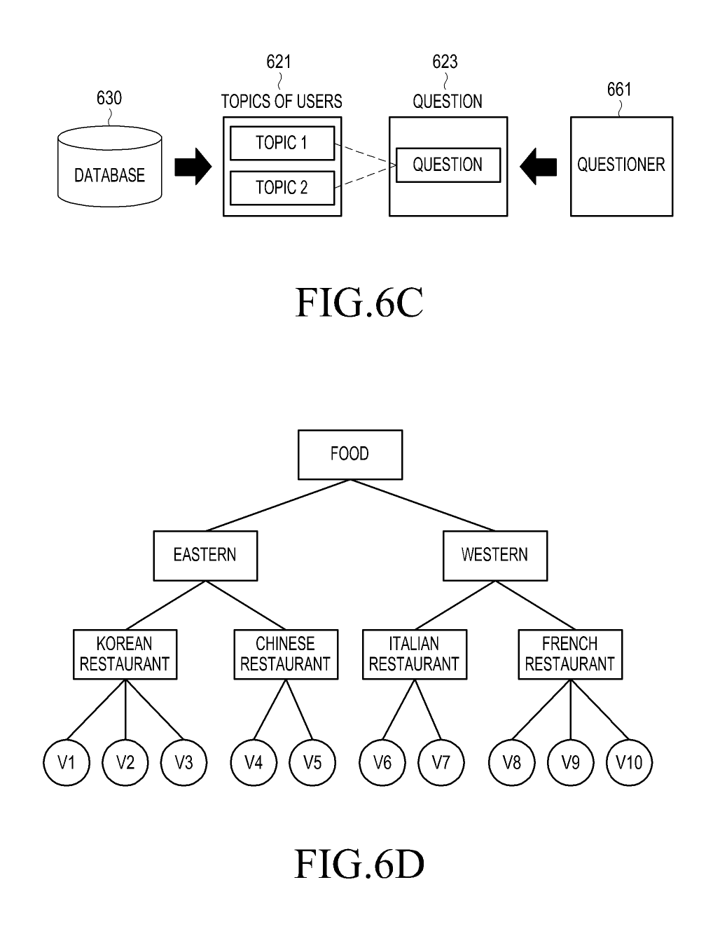

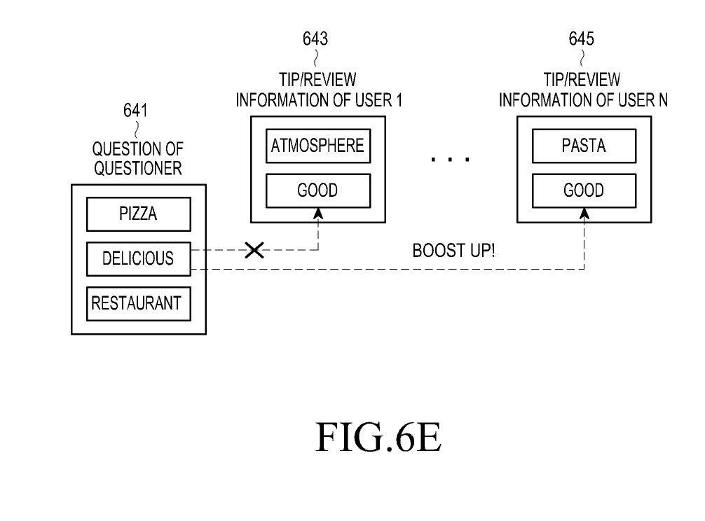

Referring to FIG. 6A, expertise for basic question information is associated with expertise of users with respect to a location, a business type, a time, a store name from among topic categories 601 of the topics extracted from the question, which may be evaluated based on expertise 605 of the users with respect to topics corresponding to the topic categories from among the topics extracted from the question (expertise of a user for a topic) and a correlation 607 between the topics corresponding to the topic categories from among the topics extracted from the question and topics 603 corresponding to the topic category selected from the visit history information (correlation between a question and a topic).

The expertise of a user of a topic (p(uⱼ|t)) may be determined by generating a profile 611 of each user for each topic category using visit history information of the users in the database 630, as shown in FIG. 6B, and calculating a conformity ratio of each generated profile 611 and a topic of a corresponding topic category of the question. For example, when the topic extracted from the question is “Sinsa dong” and a location profile 613 of user n corresponds to “Sinsa dong two times and Apgujung 1 dong three times”, a conformity ratio of the location profile 613 of the user n with a corresponding type of topic of the question may be “2/5”. In addition, the expertise score of a user for a topic may be designated for each conformity ratio. As the conformity ratio becomes higher, a higher expertise score of a user for a topic may be applied.

In addition, for the correlation between a question and a topic, a similarity between topics 621 of users and a question 623 of a questioner 661, with respect to a location, a business type, a time, a store name from among topic categories, using visit history information of the users of the database 630, as shown in FIG. 6C.

For example, a social search engine may determine whether a topic extracted from a location-based query is identical a topic selected from the visit history information, for each of at least one topic category from among a business type, a time, and a store name, using a designated hierarchical tree, or may determine whether the topic of the location-based query is included in a superordinate node or a subordinate node of the topic selected from the visit history information, so as to determine the similarity. In addition, for example, latitude and longitude information of the topic extracted from the location-based query and the topic selected from the visit history information may be determined and the similarity may be determined based on a degree of proximity between the topic extracted from the location-based query and the topic selected from the visit history information.

For example, in a case in which the hierarchical tree of FIG. 6D is used, when the topic of the question of the questioner is “café” and a topic of a user is “coffee shop”, it may be determined that the similarity between the topic of the question of the questioner and the topic of the user is high. In addition, for example, in a case in which the hierarchical tree of FIG. 6D is used, when the topic of the question of the questioner is “pasta” and a topic of a user is “Kimchi stew”, it may be determined that the similarity between the topic of the question of the questioner and the topic of the user is significantly low (little). In addition, for example, when location information such as latitude and longitude is used, when the topic of the question of the questioner is “Seokchon dong” and a topic of a user is “Songpa 1-dong” which is close to the “Seokchon dong”, it may be determined that the similarity between the topic of the question of the questioner and the topic of the user is high. In addition, the correlation score between a question and a topic may be designated based on the similarity. As the similarity becomes higher, a higher correlation score between a question and a topic may be applied.

Additionally, for the expertise of an answerer of detailed question information in Equation 1 may be acknowledged when it is determined that a topic of a question 641 of the questioner is similar to tip/review information 643 and 645 of a user, as shown in FIG. 6E.

For example, when the question 641 of the questioner is “which restaurant makes delicious Pizza?”, “Pizza”, “delicious”, and “restaurant” may be extracted as topics, for each topic category. In addition, for example, when topics of the tip or review information 643 of user 1 correspond to “atmosphere” and “good” according to the visit history information of the tip or review information 643 of user 1, and topics of the tip or review information 645 of user n correspond to “pasta” and “good”, it is determined that the question 641 of the questioner and the tip or review information 645 of user n have similar topics for the detailed information from among the topic categories. Accordingly, it is determined that user n has expertise for the detailed question information. In addition, when it is determined that user n has expertise for the detailed question information, a score designated for the expertise score associated with the detailed question information may be applied.

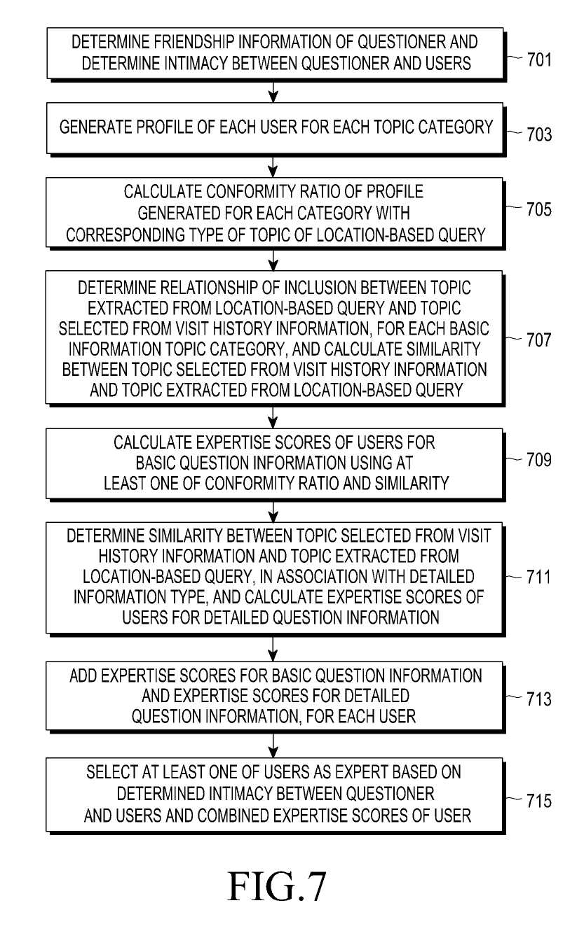

FIG. 7 is a flowchart illustrating an operation of selecting an expert in a location-based social search service operation according to an exemplary embodiment. Referring to FIG. 7, in operation 701, a social search engine may determine friendship information of a questioner so as to determine an intimacy level or relationship between the questioner and users.

In operation 703, the social search engine may generate a profile of each user for each topic category.

In operation 705, the social search engine may calculate a conformity ratio of a profile generated for each topic category with a topic of a corresponding topic category of a location-based query.

In operation 707, the social search engine may determine a relationship of inclusion between a topic extracted from the location-based query and a topic selected from the visit history information, for each basic information topic category, so as to calculate similarity between the topic selected from the visit history information and the topic extracted from the location-based query.

In operation 709, the social search engine may calculate an expertise score of a user for basic question information, using at least one of the conformity ratio and the similarity.

In operation 711, the social search engine may determine a similarity between each topic selected from the visit history information and a topic extracted from the location-based query, with respect to a detailed information type, so as to determine an expertise score of the user for the detailed question information.

In operation 713, the social search engine may add the expertise score of the user for the basic question information and the expertise score of the user for the detailed question information.

In operation 715, the social search engine may select at least one of the users as an expert, based on the intimacy between the questioner and the users and the combined expertise scores obtained for each user.

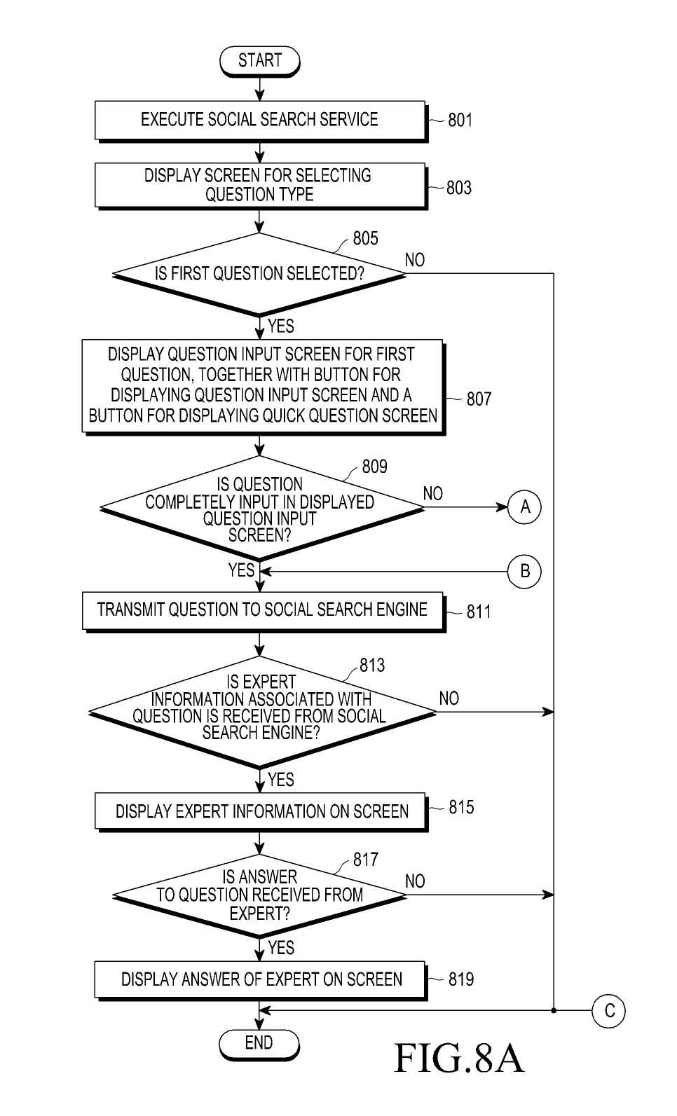

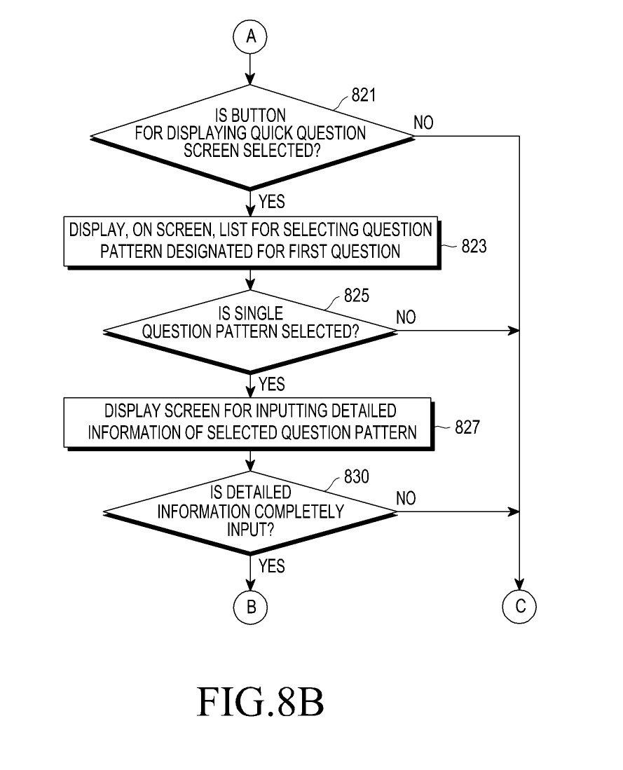

FIGS. 8A and 8B are flowcharts illustrating a location-based social search operation of an electronic device that uses a location-based social search service according to an exemplary embodiment. In particular, FIGS. 8A and 8B correspond to an exemplary embodiment of a location-based social search operation of an electronic device when a user executes the location-based social search service in the electronic device, inputs a question, and obtains expert information.

Referring to FIGS. 8A and 8B, in operation 801, an electronic device may execute a social search service based on an operation by a user.

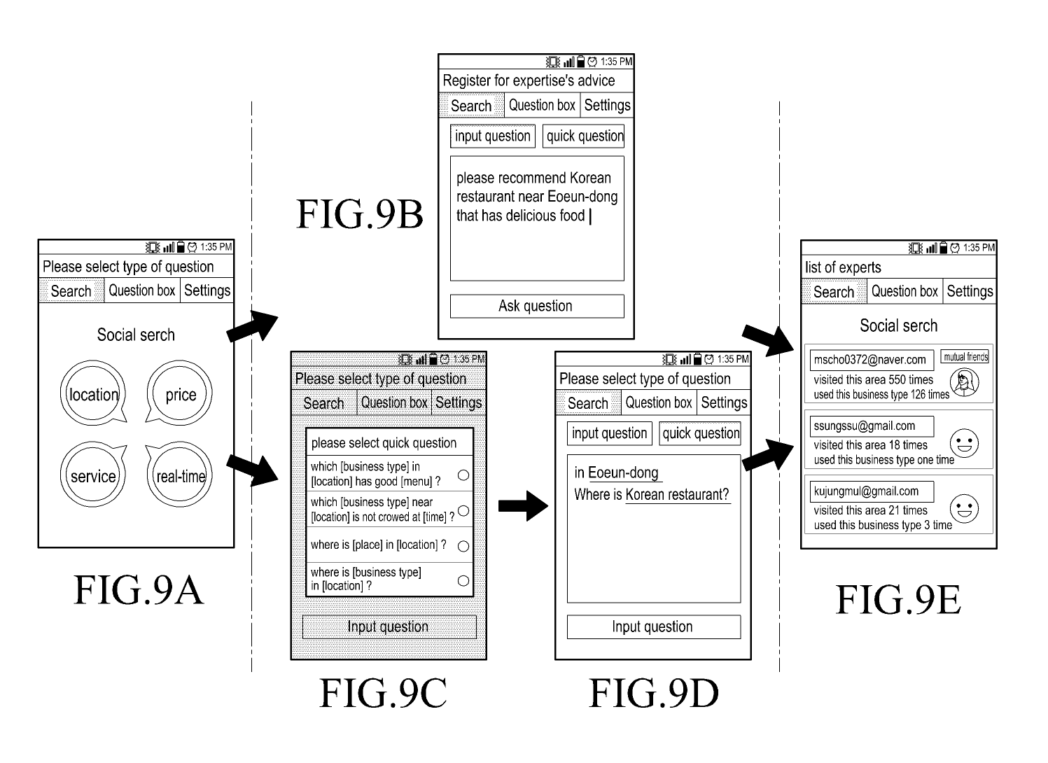

In operation 803, the electronic device may display, on a display of the electronic device, a screen for selecting a question type of a question that the user desires to ask (execute a search), as the social search service is executed. The screen for selecting the question type may display, for example, a location button (also referred to as an icon) for executing a search in association with a location, a price button for executing a search in association with a price, a service button for executing a search in association with a service, and a real-time button for executing a search in association with the present, as shown in FIG. 9A.

In operation 805, the electronic device may determine whether a first question is selected, based on an operation by the user. When the electronic device determines that the first question is selected in operation 805, the electronic device may execute operation 807. When the electronic device determines that the first question is not selected in operation 805, the electronic device may terminate the operation of the exemplary embodiment.

In operation 807, the electronic device may display, on a display of the electronic device, a question input screen for the first question together with a button for displaying a question input screen and a button for displaying a quick question screen.

According to an operation by the user, when the electronic device selects, for example, a location button from among the four displayed buttons in FIG. 9A, a question input screen in which a user directly inputs a question under an ‘input a question’ item through an input unit of the electronic device may be displayed in the display of the electronic device. In addition, an item for selecting the display of the quick question screen may be located and displayed next to the input a question' item, so as to convert a screen and to display the quick question screen instead of the question input screen. The quick question screen may display, on a screen, a question pattern designated for a corresponding question type, based on a question type selected by the user, and may enable the user to select the question pattern.

In operation 809, the electronic device may determine whether the question is completely input in the displayed question input screen. When the electronic device determines that a question is completely input in the displayed question input screen in operation 809, the electronic device may execute operation 811. When the electronic device determines that a question is not completely input in the displayed question input screen in operation 809, the electronic device may execute operation 821.

In operation 811, the electronic device may transmit the completely input question to the social search engine.

In operation 813, the electronic device may determine whether expert information associated with the question is received from the social search engine. When the electronic device determines that the expert information associated with the question is received from the social search engine in operation 813, the electronic device may execute operation 815. When the electronic device determines that the expert information associated with the question is not received from the social search engine in operation 813, the electronic device may terminate the operation of the exemplary embodiment.

In operation 815, the electronic device may display the expert information received from the social search engine. Referring to FIG. 9E, the received expert information may be listed and may be displayed on a screen. The received expert information may include an identification (ID), a profile picture, a friendship with a user (questioner) who uses an electronic device, information associated with visit history information corresponding to a question (for example, the number of times of visiting a corresponding area, the number of times of utilizing a business type corresponding to a question, and the like), and the like.

In operation 817, the electronic device may determine whether an answer to the question is received from the expert. When the electronic device determines that the answer to the question is received from the expert, the electronic device may execute operation 819. When the electronic device determines that the answer to the question is not received from the expert in operation 817, the electronic device may terminate the operation of the present disclosure.

In operation 819, the electronic device may display, on the screen, the answer received from the expert.

In operation 821, the electronic device may determine whether a button for displaying the quick question screen is selected, based on an operation by the user. When the electronic device determines that the button for displaying the quick question screen is selected based on the operation by the user in operation 821, the electronic device may execute operation 823. When the electronic device determines that the button for displaying the quick question screen is not selected based on the operation by the user in operation 821, the electronic device may terminate the operation of the exemplary embodiment.

In operation 823, the electronic device may display, on the screen, a list for selecting a designated question pattern in association with the first question. For example, when the location button is selected based on an operation by the user in the screen of FIG. 9A, and the button for displaying the quick question screen is selected, the list for selecting a question pattern, such as, “which [business type] in [location] has good [menu]?”, “which [business type] near [location] is not crowed at [time]?”, “where is [place] in [location]?”, “where is [business type] in [location]?”, and the like, may be displayed on the screen.

In operation 825, the electronic device may determine whether a single question pattern is selected, based on an operation by the user. When the electronic device determines that a single question pattern is selected based on an operation by the user in operation 825, the electronic device may execute operation 827. When the electronic device determines that a single question pattern is not selected based on an operation by the user in operation 825, the electronic device may terminate the operation of the exemplary embodiment.

In operation 827, the electronic device may display a screen for inputting detailed information of the selected question pattern, as shown in FIG. 9D. For example, when “where is [business type] in [location]?” is selected based on an operation by the user in FIG. 9C, a screen for inputting a location and a business type is displayed, and the user may input the location and the business type as shown in FIG. 9D.

In operation 830, the electronic device may determine whether to complete inputting the detailed information. When the electronic device determines that the detailed information is completely input in operation 830, the electronic device may execute operation 811. When the electronic device determines that inputting the detailed information is not completed in operation 830, the electronic device may terminate the operation of the exemplary embodiment.

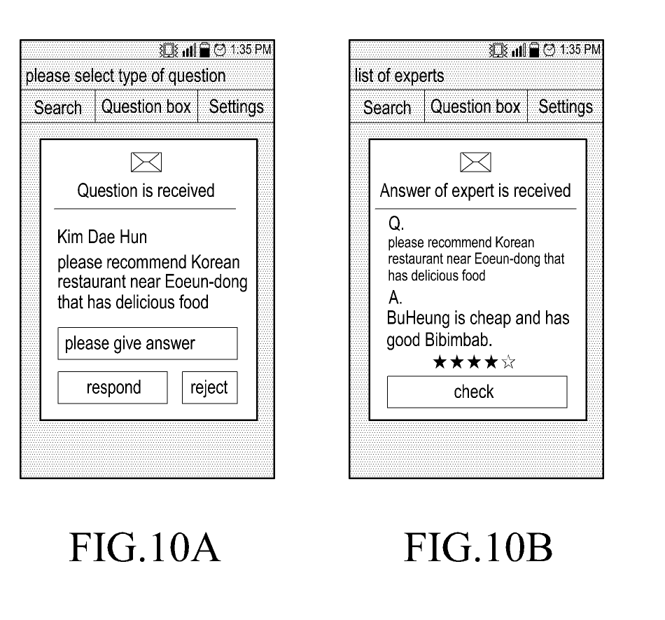

According to the above described operations, when the question of the questioner is transferred to the expert, a screen reporting that the question of the questioner is received may be displayed in an electronic device of the expert, as shown in FIG. 10A. Referring to FIG. 10A, the screen reporting that the question of the questioner is received may include a message indicating that a question is received, a name of an expert (or an ID or an e-mail address of the expert), and the question of the questioner. In addition, the screen may include an answer input box through which an expert may provide an answer to a received question, a response button for sending an answer to a questioner after inputting the answer, and a reject button for rejecting to answer a question.

Additionally, according to the above described operations, when an answer to the question of the questioner is received from the expert, a screen for reporting that the answer to the question of the questioner is received from the expert may be displayed in an electronic device of the questioner, as shown in FIG. 10B. Referring to FIG. 10B, the screen reporting that the answer is received from the expert may include a message indicating that an answer is received from an expert, and a question and a response of the questioner.

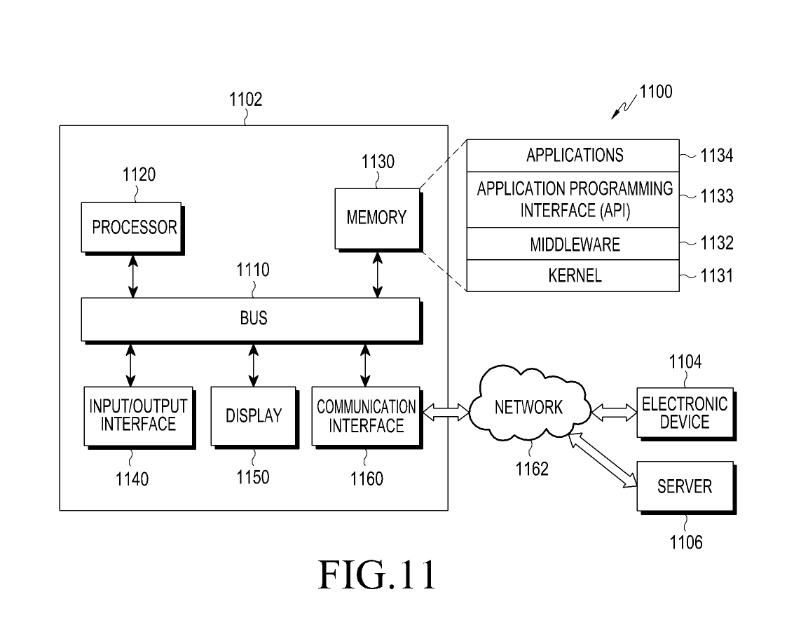

FIG. 11 is a block diagram of a network environment including an electronic device according to various exemplary embodiments. Referring to FIG. 11, an electronic device 1102 may include a bus 1110, a processor 1120, a memory 1130, an input/output interface 1140, a display 1150, and a communication interface 1160. The bus 1110 may be a circuit for connecting component elements of the electronic device 1102 and for transferring communication, for example, a control message, between the component elements.

The processor 1120 may, for example, receive a command from other component elements, for example, the memory 1130, the input/output interface 1140, the display 1150, the communication interface 1160, and the like, through the bus 1110, may decrypt the received command, and may execute operation or data processing based on the decrypted command.

The memory 1130 may store a command or data received from the processor 1120 or other component elements, for example, the input/output interface 1140, the display 1150, the communication interface 1160, and the like, or may store a command or data generated by the processor 1120 or other component elements. The memory 1130 may include programming modules, for example, a kernel 1131, middleware 1132, an Application Programming Interface (API) 1133, applications 1134, and the like. Each of the programming modules may be formed of software, firmware, and hardware, or a combination of at least two of them.

The kernel 1131 may control or manage system resources, for example, the bus 1110, the processor 1120, the memory 1130, and the like, used for executing an operation or function implemented in other programming modules, for example, the middleware 1132, the API 1133, or the application 1134. Also, the kernel 1131 may provide an interface that enables the middleware 1132, the API 1133, or the application 1134 to access an individual component element of the electronic device 1102 for control or management.

The middleware 1132 may execute as a relay so that the API 1133 or the application 1134 executes communication with the kernel 1131, and receives and transmits data. Also, in association with operation requests received from the application 1134, the middleware 1132 may execute a control, for example, scheduling or load balancing, for an operation request, through use of, for example, a method of assigning, to at least one of the application 1134, a priority of use of a system resource of the electronic device 1102, for example, the bus 1110, the processor 1120, the memory 1130, or the like.

The API 1133 is an interface used by the application 1134 to control a function provided in the kernel 1131 or the middleware 1132, and may include, for example, at least one interface or function, for example, an instruction, for a file control, a window control, image processing, a character control, or the like.

According to various exemplary embodiments, the applications 1134 may include, but are not limited to, an SMS/MMS application, an e-mail application, a calendar application, an alarm application, a health care application, for example, an application for measuring an amount of exercise or blood sugar, and an environmental information application, for example, an application for providing an atmospheric pressure, humidity information, temperature information, and the like. Additionally or alternatively, the application 1134 may be an application associated with exchanging of information between the electronic device 1102 and an external electronic device, for example, an electronic device 1104. The application associated with exchanging of information may include, for example, a notification relay application for transferring predetermined information to an external electronic device or a device management application for managing an external electronic device.

For example, the notification relay application may include a function of transferring, to the external electronic device, for example, the electronic device 1104, notification information generated from other applications of the electronic device 1102, for example, an SMS/MMS application, an e-mail application, a health management application, an environmental information application, and the like. Additionally or alternatively, the notification relay application may receive notification information from, for example, an external electronic device, for example, the electronic device 1104, and may provide the notification information to a user. The device management application may manage (for example, install, delete, or update), for example, a function of at least a part of an external electronic device (for example, the electronic device 1104) that communicates with the electronic device 1102 (for example, activating/deactivating the external electronic device (or a few component elements) or adjusting brightness (or resolution) of a display), an application operated in the external electronic device, or a service provided in the external electronic device (for example, a call service or a message service).

According to various exemplary embodiments, the applications 1134 may include an application designated based on properties (for example, a type of electronic device) of an external electronic device (for example, the electronic device 1104). For example, when the external electronic device is an MP3 player, the applications 1134 may include an application related to the reproduction of music. Similarly, when the external electronic device is a mobile medical device, the applications 1134 may include an application related to health care. According to an exemplary embodiment, the applications 1134 may include at least one of an application received from an application designated for the electronic device 1102 and an application received from an external electronic device (for example, the server 1106 or the electronic device 1104).

The input/output interface 1140 may transfer a command or data input by a user through an input/output device (for example, a sensor, a keyboard, or a touch screen) to the processor 1120, the memory 1130, and the communication interface 1160, for example, through the bus 1110. For example, the input/output interface 1140 may provide, to the processor 1120, data associated with a touch of a user input through a touch screen. The input/output interface 1140 may output a command or data received, for example, through the bus 1110 from the processor 1120, the memory 1130, and the communication interface 1160, to an input/output device (for example, a speaker or display).

The display 1150 may display various pieces of information (for example, multimedia data, text data, and the like) to a user.

The communication interface 1160 may establish communication between the electronic device 1102 and an external electronic device (for example, the electronic device 1104 or the server 1106). For example, the communication interface 1160 may be connected to a network 1162 through wireless communication or wired communication, and may communicate with an external device. Wireless communication may include at least one of, for example, Wireless Fidelity (Wifi), Bluetooth (BT), Near Field Communication (NFC), Global Positioning System (GPS) and cellular communication (for example, Long Term Evolution (LTE), LTE-A, Code Division Multiple Access (CDMA), Wideband CDMA (WCDMA), UMTS, WiBro, GSM or the like). The wired communication may include at least one of, for example, a Universal Serial Bus (USB), a High Definition Multimedia Interface (HDMI), Recommended Standard 232 (RS-232), and a Plain Old Telephone Service (POTS).

According to an exemplary embodiment, the network 1162 may be a telecommunication network. The communication network may include at least one of a computer network, Internet, Internet of things, and a telephone network. According to an exemplary embodiment, a protocol for communication between the electronic device 1102 and an external device (for example, a transport layer protocol, a data link layer protocol or a physical layer protocol) may be supported in at least one of the applications 1134, the API 1133, the middle ware 1132, the kernel 1131, and the communication interface 1160.

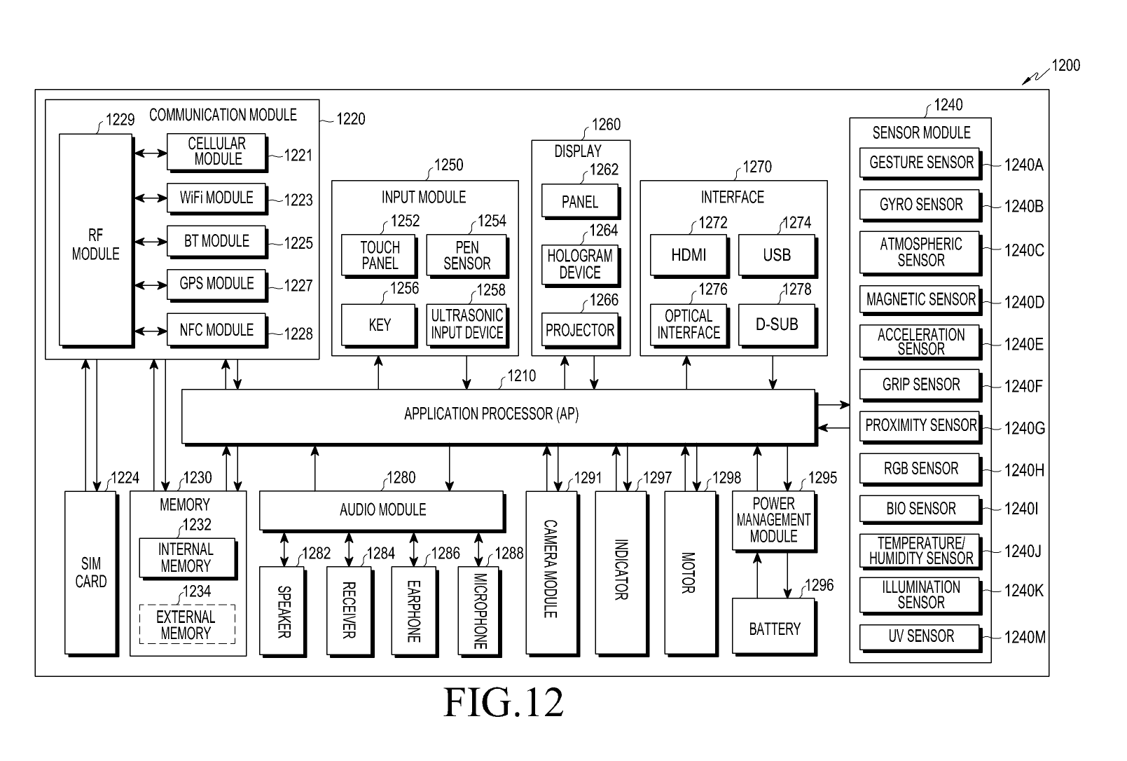

FIG. 12 is a block diagram illustrating an electronic device according to various exemplary embodiments. An electronic device 1200 may form, for example, a part or the entirety of the electronic device 1200 illustrated in FIG. 12. Referring to FIG. 12, the electronic device 1200 may include at least one application processor (AP) 1210, a communication module 1220, a Subscriber Identification Module (SIM) card 1224, a memory 1230, a sensor module 1240, an input device 1250, a display 1260, an interface 1270, an audio module 1280, a camera module 1291, a power management module 1295, a battery 1296, an indicator 1297, and a motor 1298.

The AP 1210 may control a plurality of hardware or software components connected to the AP 1210 by driving an operating system or an application program, process various data including multimedia data, and perform calculations. The AP 1210 may be embodied as, for example, a System on Chip (SoC). According to an exemplary embodiment, the AP 1210 may further include a Graphic Processing Unit (GPU) (not illustrated).

The communication module 1220 (for example, the communication interface 1260) may transmit and receive data during communication between the electronic device 1200 (for example, the electronic device 1200 and other electronic devices (for example, the electronic device 1204, the server 1206, or a social search engine) connected over a network. According to an exemplary embodiment, the communication module 1220 may include a cellular module 1221, a Wi-Fi module 1223, a BT module 1225, a GPS module 1227, an NFC module 1228, and a Radio Frequency (RF) module 1229.

The cellular module 1221 may provide a voice, a call, a video call, a text message service, or an Internet service through a communication network (for example, LTE, LTE-A, CDMA, WCDMA, UMTS, WiBro, GSM or the like). Further, the cellular module 1221 may distinguish and authenticate electronic devices within a communication network using a subscriber identification module (for example, the SIM card 1224). According to an exemplary embodiment, the cellular module 1221 may execute at least some of the functions that the AP 1210 may provide. For example, the cellular module 1221 may execute at least a part of a multimedia control function.

According to an exemplary embodiment, the cellular module 1221 may include a Communication Processor (CP). Further, the cellular module 1221 may be embodied as, for example, an SoC. Although the cellular module 1221 (for example, the CP 1211), the memory 1230, and the power management module 1295 are illustrated as components separated from the AP 1210 in FIG. 12, the AP 1210 may be embodied to include at least a few of the above described components (for example, the cellular module 1221) according to an exemplary embodiment.

According to an exemplary embodiment, the AP 1210 or the cellular module 1221 (for example, a CP) may load, to a volatile memory, a command or data received from at least one of a non-volatile memory and other components connected to each of the AP 810 and the cellular module 1221, and process the loaded command or data. Further, the AP 1210 or the cellular module 1221 may store data received from or generated by at least one of the other component elements, in a non-volatile memory.

Each of the Wi-Fi module 1223, the BT module 1225, the GPS module 1227, and the NFC module 1228 may include, for example, a processor for processing data transmitted/received through the corresponding module. In FIG. 12, the cellular module 1221, the WiFi module 1223, the BT module 1225, the GPS module 1227, and the NFC module 1228 are illustrated as blocks separated from one another, but at least a few (for example, two or more) of the cellular module 1221, the WiFi module 1223, the BT module 1225, the GPS module 1227, and the NFC module 1228 may be included in one Integrated Chip (IC) or one IC package. For example, at least a few (for example, a CP corresponding to the cellular module 1221 and a Wi-Fi processor corresponding to the Wi-Fi module 1223) of processors corresponding to the cellular module 1221, the Wi-Fi module 1223, the BT module 1225, the GPS module 1227, and the NFC module 1228, respectively, may be embodied as a single SoC.

The RF module 1229 may transmit/receive data, for example, an RF signal. Although not illustrated, the RF module 1229 may include, for example, a transceiver, a Power Amp Module (PAM), a frequency filter, a Low Noise Amplifier (LNA), or the like. Further, the RF unit 1229 may further include a component for transmitting/receiving an electromagnetic wave in the air in wireless communication, such as a conductor, a conducting wire, and the like. Although the cellular module 1221, the Wi-Fi module 1223, the BT module 1225, the GPS module 1227, and the NFC module 1228 are illustrated to share one RF module 1229 in FIG. 12, at least one of the cellular module 1221, the Wi-Fi module 1223, the BT module 1225, the GPS module 1227, and the NFC module 1228 may transmit/receive the RF signal through a separate RF module.

The SIM card 1224 may be a card including a subscriber identification module, and may be inserted into a slot formed in a predetermined portion of an electronic device. The SIM card 1224 may include unique identification information (for example, an Integrated Circuit Card IDentifier (ICCID)) or subscriber information (for example, an International Mobile Subscriber Identity (IMSI)).

The memory 1230 may include an embedded memory 1232 or an external memory 1234. The embedded memory 1232 may include, for example, at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an exemplary embodiment, the embedded memory 1232 may be a Solid State Drive (SSD). The external memory 1234 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 1234 may be functionally connected to the electronic device 1200 through various interfaces. According to an exemplary embodiment, the electronic device 1200 may further include a storage device (or storage medium) such as a hard drive.

The sensor module 1240 may measure a physical quantity or detect an operation state of the electronic device 1200, and may convert the measured or detected information to an electronic signal. The sensor module 1240 may include at least one of, for example, a gesture sensor 1240A, a gyro sensor 1240B, an atmospheric pressure sensor 1240C, a magnetic sensor 1240D, an acceleration sensor 1240E, a grip sensor 1240F, a proximity sensor 1240G, a color sensor 1240H (for example, a Red/Green/Blue (RGB) sensor), a biometric sensor 1240I, a temperature/humidity sensor 1240J, an illumination sensor 1240K, and an Ultra Violet (UV) sensor 1240M. Additionally or alternatively, the sensor module 1240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), an InfraRed (IR) sensor (not illustrated), an iris sensor (not illustrated), a fingerprint sensor (not illustrated) and the like. The sensor module 1240 may further include a control circuit for controlling one or more sensors included therein.

The input device 1250 may include a touch panel 1252, a (digital) pen sensor 1254, a key input device 1256, or an ultrasonic input device 1258. The touch panel 1252 may recognize a touch input through at least one of, for example, a capacitive scheme, a resistive scheme, an infrared scheme, and an ultrasonic scheme. The touch panel 1252 may further include a control circuit. The capacitive scheme touch panel may recognize a physical contact or proximity. The touch panel 1252 may further include a tactile layer. In this case, the touch panel 1252 may provide a tactile reaction to a user.

The (digital) pen sensor 1254 may be embodied, for example, using a method identical or similar to a method of receiving a touch input of a user, or using a separate recognition sheet. The key 1256 may include, for example, a physical button, an optical key or a keypad. The ultrasonic input device 1258 is a device which may detect an acoustic wave using a microphone (for example, microphone 1288) of the electronic device 1200 through an input tool generating an ultrasonic signal, to identify data and may perform wireless recognition. According to an exemplary embodiment, the electronic device 1200 may receive a user input from an external device (for example, a computer or a server) connected to the electronic device 1200 by using the communication module 1220.

The display 1260 may include a panel 1262, a hologram device 1264, or a projector 1266. The panel 1262 may be, for example, a Liquid Crystal Display (LCD), Active-Matrix Organic Light Emitting Diode (AM-OLED), or the like. The panel 1262 may be embodied to be, for example, flexible, transparent, or wearable. The panel 1262 may be embodied as a single module with the touch panel 1252. The hologram device 1264 may show a stereoscopic image in the air by using interference of light. The projector 1266 may project light onto a screen to display an image. For example, the screen may be located inside or outside the electronic device 1200. According to an exemplary embodiment, the display 1260 may further include a control circuit for controlling the panel 1262, the hologram device 1264, or the projector 1266.

The interface 1270 may include, for example, a High-Definition Multimedia Interface (HDMI) 1272, a Universal Serial Bus (USB) 1274, an optical interface 1276, or a D-subminiature (D-sub) 1278. Additionally or alternatively, the interface 1270 may include, for example, a Mobile High-definition Link (MHL) interface, a Secure Digital (SD) card/Multi-Media Card (MMC) interface, or an Infrared Data Association (IrDA) standard interface.

The audio module 1280 may bidirectionally convert a sound and an electronic signal. The audio module 1280 may process voice information input or output through, for example, a speaker 1282, a receiver 1284, earphones 1286, the microphone 1288 or the like.

The camera module 1291 is a device which photographs a still image and a moving image. According to an exemplary embodiment, the camera module 1291 may include one or more image sensors (for example, a front side sensor or a back side sensor), a lens (not illustrated), an Image Signal Processor (ISP) (not shown) or a flash (not illustrated) (for example, LED or xenon lamp).

The power management module 1295 may manage power of the electronic device 1200. Although not illustrated, the power management module 1295 may include, for example, a Power Management Integrated Circuit (PMIC), a charger Integrated Circuit (IC), or a battery or fuel gauge.

The PMIC may be mounted to, for example, an integrated circuit or an SoC semiconductor. Charging methods may be classified into a wired charging method and a wireless charging method. The charger IC may charge a battery and prevent the flow of over voltage or over current from a charger. According to an exemplary embodiment, the charger IC may include a charger IC for at least one of the wired charging method and the wireless charging method. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added.

The battery fuel gauge may measure, for example, the remaining amount of battery power, or a voltage, a current, or a temperature during charging. The battery 1296 may store or generate electricity, and may supply power to the electronic device 1200 using the stored or generated electricity. The battery 1296 may include, for example, a rechargeable battery or a solar battery.

The indicator 1297 may display a particular status of the electronic device 1200 or a part thereof (for example, the AP 1210), for example, a boot-up state, a message state, a charging state, or the like. The motor 1298 may convert an electrical signal into a mechanical vibration. Although not illustrated, the electronic device 1200 may include a processort (for example, GPU) for supporting a mobile TV. The processort for supporting the mobile TV may process media data according to a standard of Digital Multimedia Broadcasting (DMB), Digital Video Broadcasting (DVB), media flow or the like.

The above described components of the electronic device according to various exemplary embodiments may be formed of one or more components, and a name of a corresponding component element may be changed based on the type of electronic device. The electronic device according to the exemplary embodiments may include one or more of the aforementioned components or may further include other additional components, or some of the aforementioned components may be omitted. Further, some of the components of the electronic device according to the various exemplary embodiments may be combined to form a single entity, and thus, may equivalently execute functions of the corresponding elements prior to the combination.

The “module” used in various exemplary embodiments may refer to, for example, a “unit” including one of hardware, software, and firmware, or a combination of two or more of the hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to various exemplary embodiments may include at least one of an Application-Specific Integrated Circuit (ASIC) chip, a Field-Programmable Gate Arrays (FPGAs), and a programmable-logic device for performing operations which have been known or are to be developed hereafter.

According to various exemplary embodiments, at least part of a device (for example, modules or functions thereof) or a method (for example, operations) according to the various exemplary embodiments may be embodied by, for example, an instruction stored in a computer readable storage medium provided in a form of a programming module. When the command is executed by one or more processors, the one or more processors may perform a function corresponding to the command The computer-readable storage medium may be, for example, the memory. At least some of the programming modules may be implemented (for example, executed) by, for example, the processor. At least a part of the programming module may include, for example, a module, a program, a routine, a set of instructions and/or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of various exemplary embodiments, and vice versa.

Exemplary embodiments provided in the present specifications and drawings are merely certain examples to readily describe the technology associated with exemplary embodiments and to help understanding of the exemplary embodiments, but may not limit the scope of the exemplary embodiments. Therefore, in addition to the exemplary embodiments disclosed herein, the scope of the various exemplary embodiments should be construed to include all modifications or modified forms drawn based on the technical idea of the various exemplary embodiments.

It will be appreciated that the exemplary embodiments may be implemented in a form of hardware, software, a combination of hardware and software. Regardless of being erasable or re-recordable, such an optional software may be stored in a non-volatile storage device such as a ROM, a memory such as an RAM, a memory chip, a memory device, or an integrated circuit, or a storage medium such as a CD, a DVD, a magnetic disc, or a magnetic tape that is optically or electromagnetically recordable and readable by a machine, for example, a computer. It is appreciated that the storage included in the electronic device is one example of the machine-readable storage media suitable for storing a program or programs including commands for implementing various exemplary embodiments. Accordingly, the exemplary embodiment includes a program that includes a code for implementing an apparatus or a method defined in any claim in the present specification and a machine-readable storage medium that stores such a program. Further, the program may be electronically transferred by a predetermined medium such as a communication signal transferred through a wired or wireless connection, and the present disclosure appropriately includes equivalents of the program.

What is claimed is:

1. A method of providing a location-based social search service, the method comprising:
collecting, from a social network system, one or more pieces of visit history information comprising at least one of visit information of a plurality of social search service users associated with at least one of a location and review data associated with the location, and storing the collected information;
selecting a first topic for each topic category from the visit history information;
extracting a second topic for each of the topic categories from a location-based query when the location-based query is received from at least one of the social search service users; and
analyzing, for each topic category, a relationship between the second topic extracted from the location-based query, and the first topic selected from the visit history information, and selecting at least one of the social search service users as an expert.

2. The method of claim 1, wherein selecting as the expert comprises:
determining at least one result from among a result of a conformity ratio of each user with the topic extracted from the location-based query for each topic category, a result of similarity between the topic selected from the visit history information and the topic extracted from the location-based query based on a relationship between the topic extracted from the location-based query and the topic selected from the visit history information, and a result of determining a co-identity between the topic selected from the visit history information and the topic extracted from the location-based query, with respect to at least one topic category;
calculating scores for each user, based on the determined at least one result; and
selecting the expert based on the calculated scores of each user.

3. The method of claim 2, wherein the determining the result of the conformity ratio comprises:
generating a profile of each user for each topic category; and
calculating a conformity ratio of the profile generated for each topic category with a topic of a corresponding topic category of the location-based query.

4. The method of claim 2, wherein the topic category comprises at least one of a location, a type of business, a time, a store name, and detailed information.

5. The method of claim 4, wherein the determining the result of similarity comprises:
determining the similarity by at least one of determining whether the topic extracted from the location-based query is similar to the topic selected from the visit history information, for each of at least one topic category from among the type of business, the time, and the store name, based on a designated hierarchical tree, and determining whether a topic of the location-based query is included in a superordinate node or a subordinate node of a topic selected from the visit history information.

6. The method of claim 4, wherein the determining the result of similarity comprises:
determining latitude and longitude information of the topic extracted from the location-based query associated with the location category and the topic selected from the visit history information, and determining the similarity based on a degree of proximity between the topic extracted from the location-based query and the topic selected from the visit history information.

7. The method of claim 4, wherein determining the result of co-identity comprises:
determining whether the topic selected from the visit history information is similar to the topic extracted from the location-based query, in association with the detailed information category.

8. The method of claim 2, further comprising:
collecting friendship information of the users from the social network system and storing the collected friendship information.

9. The method of claim 8, wherein calculating the scores for each user further comprises:
applying extra scores to a user who is a friend with at least one of the users.

10. The method of claim 1, further comprising:
transmitting the location-based query to the selected expert; and
transmitting information associated with the selected expert to at least one user.

11. An apparatus which provides a location-based social search service, the apparatus comprising:
a communication unit; and
a controller configured to execute a control operation to receive, from a social network system, one or more pieces of visit history information comprising at least one of visit information of a plurality of social search service users associated with at least one of a location, and review data associated with the location, and to store the received information; to select a first topic for each topic category from the visit history information; to extract a second topic for each topic category from a location-based query when the location-based query is received from at least one of the plurality of users; to analyze, for each topic category, a relationship between the second topic extracted from the location-based query and the first topic selected from the visit history information, and to select at least one of the social search service users as an expert.

12. The apparatus of claim 11, wherein the controller is configured to execute a control operation to determine at least one result from among a result of a conformity ratio of each user with the topic extracted from the location-based query for each topic category, a result of similarity between the topic selected from the visit history information and the topic extracted from the location-based query based on a relationship between the second topic extracted from the location-based query and the first topic selected from the visit history information, and a result of determining a co-identity between the topic first selected from the visit history information and the second topic extracted from the location-based query, with respect to at least one topic category, to calculate scores for each user, based on the determined at least one result, and to select the expert based on the calculated scores.

13. The apparatus of claim 12, wherein the controller is configured to execute a control operation to generate a profile of each user for each category, and to calculate a conformity ratio of a profile generated for each category with a topic of a corresponding topic category of the location-based query.

14. The apparatus of claim 12, wherein the topic category includes at least one of a location, a type of business, a time, a store name, and detailed information.

15. The apparatus of claim 14, wherein the controller is configured to execute a control operation to determine the similarity by determining whether the topic extracted from the location-based query is similar to the first topic selected from the visit history information, for each of at least one topic category from among the type of business, the time, and the store name, using a designated hierarchical tree, or by determining whether a topic of the location-based query is included in a superordinate node or a subordinate node of a topic selected from the visit history information.

16. The apparatus of claim 14, wherein the controller is configured to execute a control operation to determine latitude and longitude information of the second topic extracted from the location-based query in association with the location category and a topic selected from the visit history information, and to determine the similarity based on a degree of proximity between the second topic extracted from the location-based query and the first topic selected from the visit history information.

17. The apparatus of claim 14, wherein the controller is configured to execute a control operation to determine whether the first topic selected from the visit history information is similar to the second topic extracted from the location-based query, in association with the detailed information category.

18. The apparatus of claim 12, wherein the controller is configured to execute a control operation to collect friendship information of the users from the social network system through the communication unit, and to store the information in a database.

19. The apparatus of claim 18, wherein the controller is further configured to execute a control operation to apply extra scores to a user who is a friend with at least one user.

20. The apparatus of claim 11, wherein the controller is configured to execute a control operation to transmit the location-based query to the selected expert through the communication unit, and to transmit information associated with the selected expert to at least one user.
